(19) United States
(12) Patent Application Publication
(10) Pub. No.: US 2015/0095800 A1
(43) Pub. Date: Apr. 2, 2015

(54) PRIORITIZING COMMUNICATIONS BASED ON COMMUNICATION PATTERNS

(71) Applicant: Microsoft Corporation, Redmond, WA (US)

(72) Inventors: Samuel Koppes, Bothell, WA (US); Neal Myerson, Seattle, WA (US); Srikrishna Gali, Redmond, WA (US); Paul Lo, Mill Creek, WA (US); Joseph Masterson, Renton, WA (US)

(73) Assignee: MICROSOFT CORPORATION, Redmond, WA (US)

(21) Appl. No.: 14/042,624

(22) Filed: Sep. 30, 2013

(51) Int. Cl. H04L 12/58

(52) U.S. Cl. CPC H04L 51/00
USPC 715/752

(57) ABSTRACT

A system for prioritizing communications for review by a user based on communication patterns between the user and the user's contacts is provided. The prioritization system generates a score for a contact based at least in part on a communication pattern between the user and the contact. The score indicates a likelihood that the user will want to give a high priority to reviewing communication from that contact. If the score satisfies a priority criterion, the prioritization system identifies communications from that contact that have not yet been reviewed by the user. When scores for multiple contacts satisfy the priority criterion, the prioritization system may order the contacts based on their scores.

### BACKGROUND

In many organizations, the primary mode of communication is electronic. Such communications include electronic mail messages, text messages, instant messages, voice mail messages, blog postings, discussion thread postings, and so on. A member of such an organization may receive hundreds of such communications every day, even excluding spam communications that may be effectively handled by a spam filter. Because of the vast number of communications that are received, it can be a challenge for a member to prioritize the communications for review and response. Indeed, a member may not even realize that a communication that should be given high priority has been received. For example, a member who has sent a proposal to a potential customer may need to respond immediately to any follow-up emails from that potential customer. If the member fails to realize that such a follow-up email has been received and a response is delayed or not sent, the potential customer may decide to accept a proposal from another organization that appears to be more responsive.

Various techniques have been used to help ensure high priority communications are identified and responded to in a timely manner. For example, some electronic mail systems allow a sender of an electronic mail message to designate the message as having a high importance as a notification to the recipient. There are, however, several disadvantages to such a technique. First, a sender's view of whether a message is important may be very different from the recipient's view. An email that is viewed as important by a sender may not be viewed as important by the recipient, and vice versa. Second, even if both the sender and recipient would view a message as having high importance, the sender may simply forget to designate that message as having high importance. Third, if too many messages are designated as having high importance, it will be a challenge for recipient to prioritize even among those “high importance” messages.

As another example of a technique for prioritizing communications, a recipient may sort their email messages by sender and then scan for communications from certain senders that the recipient deems as important senders. A difficulty with such an technique is that the recipient may have already responded to all the communications from those important senders and thus the recipient wastes time trying to find communications that do not exist. Another difficulty is that the recipient, continuing with the example described above, may not remember the name of the person to whom the proposal was sent and thus fail to recognize that an email is from a person who should be given high priority.

FIG. 1 illustrates a display page of a typical email program listing emails sorted by received date. The display page 100 lists the emails sent by or received by a user named Aaron. The display page 100 includes a from column, a to column, a received column, and a subject column. The emails are ordered based on the received time. The listing 101 indicates that an email was received from Bob on 8/1/13. An underlined listing indicates that the email has not been reviewed by the user. So, for example, the listing 101 is underlined because the corresponding email has not been reviewed by Aaron, while the listing 102 is not underlined because the corresponding email was reviewed by Aaron. The difficulty with the list of display page 100 is that it is difficult for the user to discern which emails should be given the highest priority for review.

FIG. 2 illustrates a display page of a typical email program listing emails sorted by sender. The display page 200 lists the same emails of the display page 100 but sorted based on sender. In this example, the emails from Carol are listed before the emails from Dan and Eric. However, since Aaron has neither responded to nor reviewed any of Carol's emails, it is unlikely that Aaron would place a high priority on reviewing Carol's emails. Nevertheless, Aaron may need to page through several pages to get past Carol's emails to the emails of other contacts that may have a high priority.

### SUMMARY

A system for prioritizing communications for review by a user based on communications between the user and the user's contacts is provided. A prioritization system may, for each of a plurality of contacts, analyze communications generated by the user for review by that contact. The prioritization system may then select contacts for which the analysis of the communications generated by the user for review by the contact indicates that the analyzed communications satisfy a priority criterion. The prioritization system may present to the user indications of communications generated by at least some of the selected contacts for review by the user.

When analyzing the communications, the prioritization system may generate a score for a contact based at least in part on a communication pattern between the user and that contact. The prioritization system may then select contacts whose scores satisfy a priority criterion. To help bring high priority communications to the attention of the user, the prioritization system may present the indications to the user in an order based at least in part on the scores of the contacts who generated the communications for review by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a display page of a typical email program listing emails sorted by received date.

FIG. 2 illustrates a display page of a typical email program listing emails sorted by sender.

FIG. 3 illustrates a first display page with a priority list of the prioritization system in some embodiments.

FIG. 4 illustrates a second display page with a priority list of the prioritization system in some embodiments.

FIG. 5 illustrates a third display page with a priority list of the prioritization system in some embodiments.

FIG. 6 is a block diagram that illustrates components of the prioritization system in some embodiments.

FIG. 7 is a flow diagram that illustrates the processing of the display priority list component of the prioritization system in some embodiments.

FIG. 8 is a flow diagram that illustrates the processing of the generate priority list component of the prioritization system in some embodiments.

FIG. 9 is a flow diagram that illustrates the processing of the generate score component of the prioritization system in some embodiments.

### DETAILED DESCRIPTION

A system for prioritizing communications for review by a user based on communication patterns between the user and the user's contacts is provided. In some embodiments, the prioritization system generates a score for each contact based at least in part on a communication pattern between the user and that contact. The communication pattern may be based on the recency and/or frequency of communications. For example, if a user last sent a communication to a first contact five minutes ago and a communication to a second contact two days ago, the prioritization system would consider communications with the first contact to have a higher priority than communications with the second contact. Now, if the second contact had sent communications to the user every few hours over the last two days without a response from the user, the prioritization system may still consider the communications with the first contact to have a higher priority in part because the lack of response to the recent communications of the second contact tends to indicate that the user does not consider it a priority to respond to communications of the second contact. If the user last sent a communication to a third contact 10 minutes ago, but also sent communications to the third contact 20 minutes ago and 30 minutes ago, the prioritization system may consider communications with the third contact to have a higher priority than communications with the first contact. The prioritization system considers the communications with a third contact to have a higher priority because the communications were more frequent, albeit less recent, than communications with the first contact. The prioritization system may also factor in other characteristics of a communication pattern when generating a score, such as whether the user deleted a communication without reviewing it, the average time elapsed before responding to communications of each contact, the ratio of the number of communications sent to a contact and received from a contact, and so on. The prioritization system may also factor in the type of communication when generating a score. So, for example, the prioritization system may generate a higher score when a user sends a text message rather than an email to a contact. The prioritization system may generate the scores dynamically when the user requests to view the priority of communications, may regenerate the scores whenever a communication event occurs that would have an impact on the score, or may regenerate the scores on a periodic basis. In general, the score for a contact indicates the likelihood that the user will want to review communications from that contact.

In some embodiments, the prioritization system selects contacts whose scores satisfy a priority criterion such as being above a threshold value. The prioritization system may generate a score for each contact, but the scores for all but a few contacts may be very low. Such very low scores may indicate that communications generated by those contacts should have a very low priority and should not be brought to the attention of the user. The prioritization system may allow the user to adjust the priority criterion, for example, using a slider ranging from zero to one with one being the highest priority. The prioritization system may also allow the priority criterion and/or score to be customizable via a plug-in. A plug-in for the priority criterion may factor in other attributes of the communications and/or contacts. For example, a plug-in may apply different thresholds depending on the job title of the contact so that the communications from the president of an organization may satisfy the priority criterion even though the score generated for the president is relatively low. Alternatively, the prioritization system may factor in job title of a contact when generating the score for a contact. The prioritization system may also exclude certain contacts regarding of their score based on exclusion criteria, such as the contact having a certain job title, the contact working for a certain company, the contact being in a user-specified list of excluded contacts, and so on.

In some embodiments, the prioritization system presents to the user indications of communications of at least some of the selected contacts. The prioritization system may display the pictures and the names of the selected contacts along with a numerical indication of the number of communications that have not been reviewed by the user. The prioritization system may output an audio indication of the selected contacts along with the number of communications or send a text message notification when an email is received from a contact with a high score. The prioritization system may present the indications to the user in an order based at least in part on the scores of the contacts who generated communications. The prioritization system may also display a list of the communications of the selected contacts that have not yet been reviewed by the user. The list of communications may be ordered based on the score of the contacts who generated the communications, on a date and time associated with the communications, and so on. The prioritization system may interrupt the user's workflow to draw attention to changes in the list of communications, changes in the scores of the selected contacts, changes in the contacts that are selected, and so on.

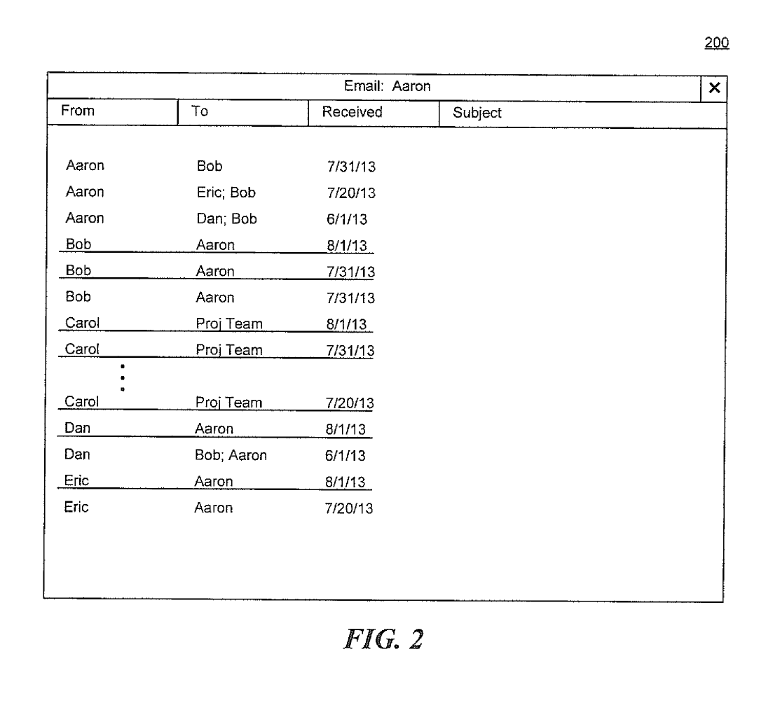

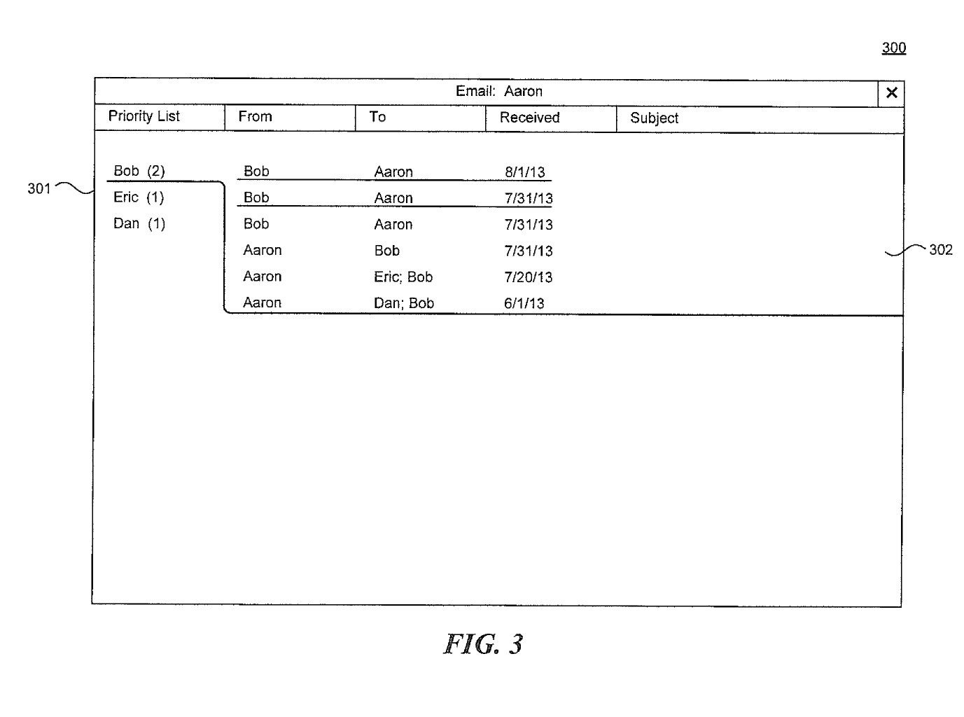

FIG. 3 illustrates a first display page with a priority list of the prioritization system in some embodiments. The display page 300 includes a priority list column along with from, to, received, and subject columns. The priority list 301 identifies the contacts Bob, Eric, and Dan, who have sent emails to the user Aaron that have not yet been reviewed by Aaron. In this example, as indicated by the parenthetical, Bob has sent two emails that have not yet been reviewed by Aaron, and Eric and Dan have each sent one email that has not been reviewed by Aaron. Referring to FIG. 2, although Carol has sent three emails that have not been reviewed by Aaron, the prioritization system would generate a relatively low score for Carol (i.e., that does not satisfy the priority criterion) since Aaron has not responded to any of Carol's emails. When the user selects one of the contacts in the priority list 301, the prioritization system displays a list 302 with the emails received from or sent to the selected contact. In this example, since Bob has been selected, the list 302 contains a listing for each email to or from Bob. Since the first two listings are underlined, Aaron has not yet reviewed those emails. Based on a review of the priority list 301 and the list 302, Aaron can quickly recognize that Bob has sent two emails that should be given a high priority for review.

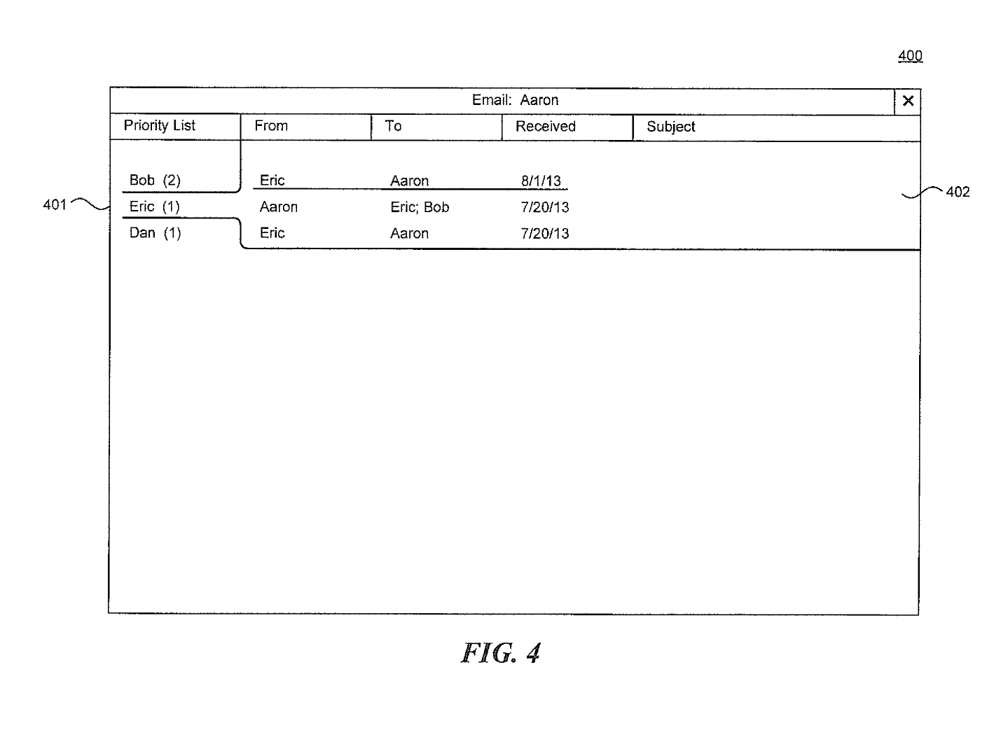

FIG. 4 illustrates a second display page with a priority list of the prioritization system in some embodiments. The display page 400 includes a priority list 401 and a list 402. The priority list indicates that the user has selected Eric, and the list 402 lists the emails sent to or from Eric.

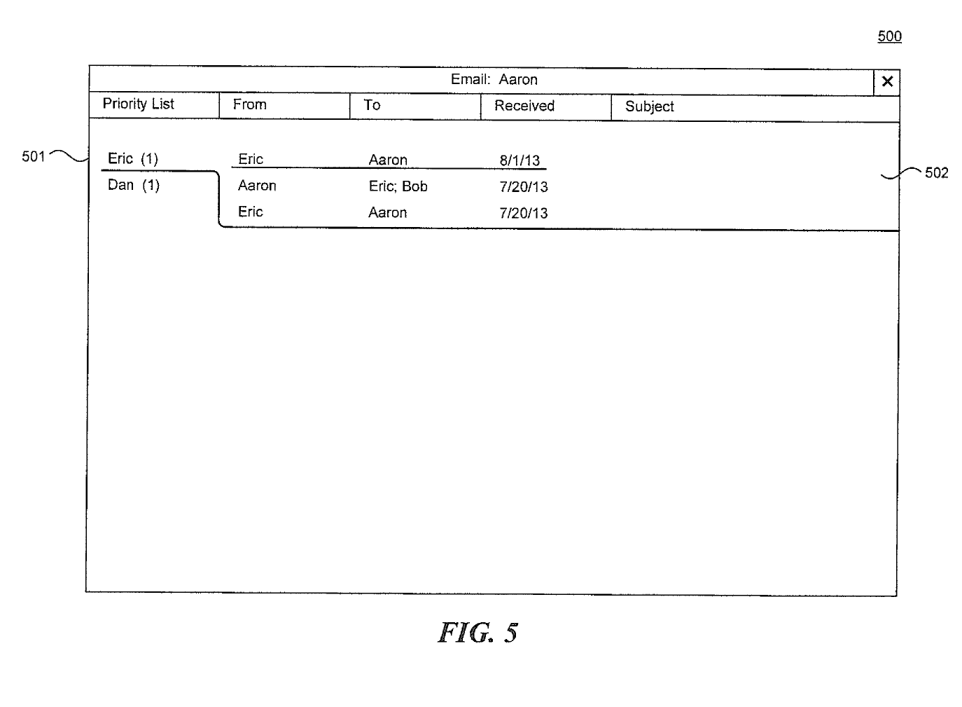

FIG. 5 illustrates a third display page with a priority list of the prioritization system in some embodiments. The display page 500 includes a priority list 501 and a list 502. In this example, the Aaron has already reviewed the two emails from Bob. Although Bob may have a higher score than Eric or Dan, the prioritization system has dropped Bob from the priority list because Aaron has already reviewed all the emails from Bob.

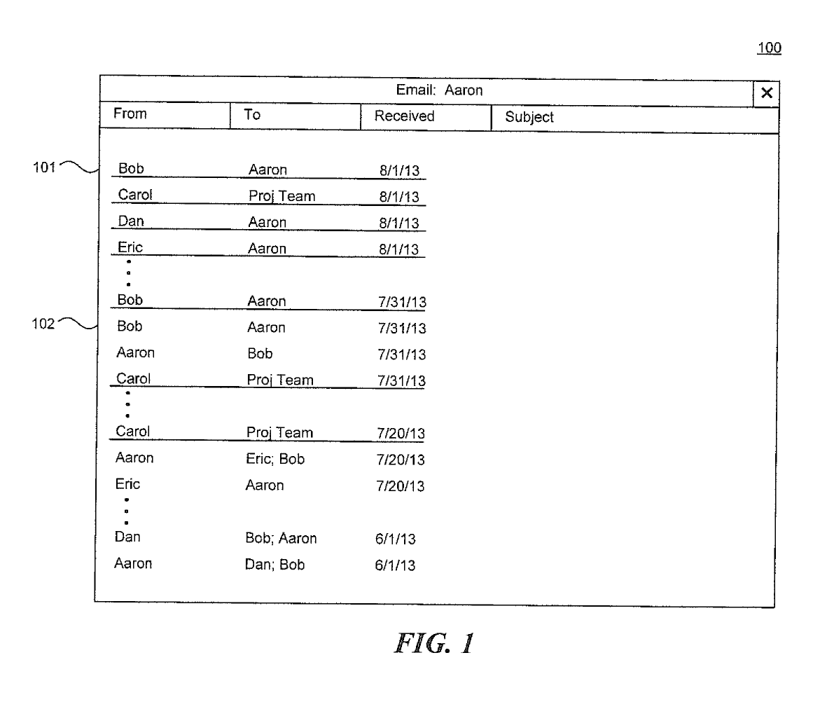

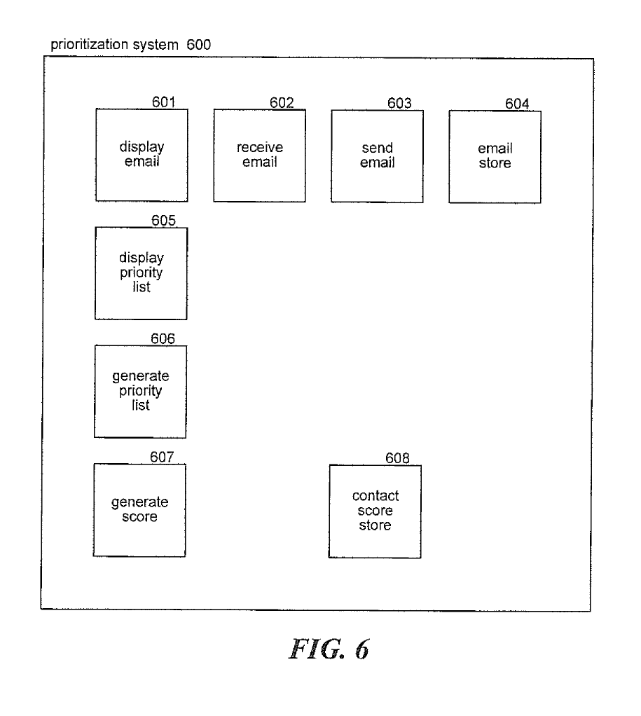

FIG. 6 is a block diagram that illustrates components of the prioritization system in some embodiments. The prioritization system 600 includes a display email component 601, a receive email component 602, a send email component 603, and an email store 604. The prioritization system 600 also includes a display priority list component 605, a generate priority list component 606, a generate score component 607, and a contact score store (repository) 608. The receive email component and the send email component may be conventional components of an email system. The email store stores the emails that have been sent or received by a user of the email system. The email system may be a server-based email system that the users access via web pages, a server-based email system that the users access using an email client, a peer-to-peer email system without a server, or an email system with some other architecture. The display email component controls the display of emails as illustrated in FIGS. 1-5. When displaying a priority list as part of the display page, the display email component invokes the display priority list component to display the priority list of contacts whose scores satisfy the priority criterion and who have sent an email that has not yet been reviewed by the user. The display priority list component invokes the generate priority list component to generate the priority list to be displayed. The generate priority list component invokes the generate score component for each of the contacts to generate a score for the contacts. The generate score component may store the scores for each contact in the contact score store. The prioritization system may also include a component to update the scores of the contacts whenever a communication event that may impact a score occurs. Although the prioritization system is illustrated in the context of an email system, the prioritization system may also be used to generate priority lists for any combination of emails, text messages, instant messages, voicemails, blog postings, conversation thread postings, document modifications, or other events that a user may want to respond to. A document modification may be considered a communication in the sense that if a user and a contact have a been working on the same document, then the user may want to review modifications recently made by that contact. Various actions that a user may take in relation to a communication may be considered to be a review of that communication by the user. So, for example, the opening of an email or the replying to, the filing of, or the deleting of the email without opening the email may each be considered review of that email. In some embodiments, the prioritization system may allow a user to manually designate a communication that has not yet been reviewed as reviewed or a communication that has been reviewed as having not been reviewed.

The computing devices on which the prioritization system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer system such as massively parallel systems. The computing devices may access computer-readable media that includes computer-readable storage media and data transmission media. The computer-readable storage media are tangible storage means that do not include a propagated signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the prioritization system. The data transmission media is media for transmitting data using propagated signals or carrier waves (e.g., electromagnetism) via a wire or wireless connection.

The prioritization system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the prioritization system may be implemented in hardware using, for example, an application-specific integrated circuit (“ASIC”).

In some embodiments, the components of the prioritization system may be implemented on a single computing device or on different computing devices. For example, the components of FIG. 6 may be implemented on a single desktop computer. As another example, the generate priority list component and the generate score component may be implemented on a server (e.g., an email server) and the other components may be implemented on a desktop computer. As another example, all the components may be implemented on a server that provides a web interface for displaying emails and priority lists.

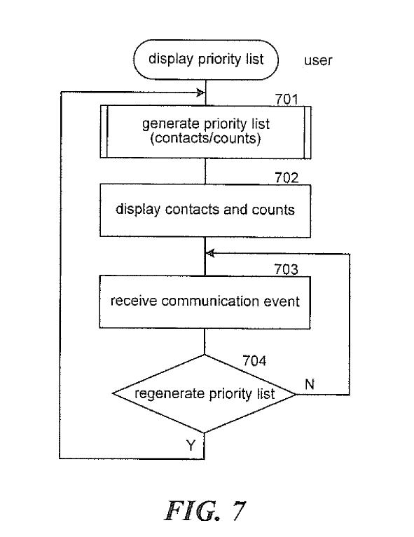

FIG. 7 is a flow diagram that illustrates the processing of the display priority list component of the prioritization system in some embodiments. The display priority list component is passed an indication of a user and generates a priority list, displays the priority list, and regenerates the priority list in response to communication events that would affect the priority. Block 701 corresponds to an embodiment of, for each of a plurality of contacts, analyzing communications generated by the user for review by that contact and selecting contacts for which the analysis of the communications generated by the user for review by the contact indicates that the analyzed communications satisfy a priority criterion. In the embodiment of block 701, the component invokes the generate priority list component for the user and receives in response the list of contacts and the counts of the communications that have not yet been reviewed by the user. Block 702 corresponds to an embodiment of presenting to the user indications of communications generated by at least some of the selected contacts for review by the user. In the embodiment of block 702, the component displays an indication of the contacts and the counts as illustrated by priority lists 301, 401, and 501. In block 703, the component waits to receive a communication event, which may affect the priority. In decision block 704, if a communication event is received that affects the priority, then the component loops to block 701 to regenerate the priority list, else the component loops to block 703 to receive the next communication event.

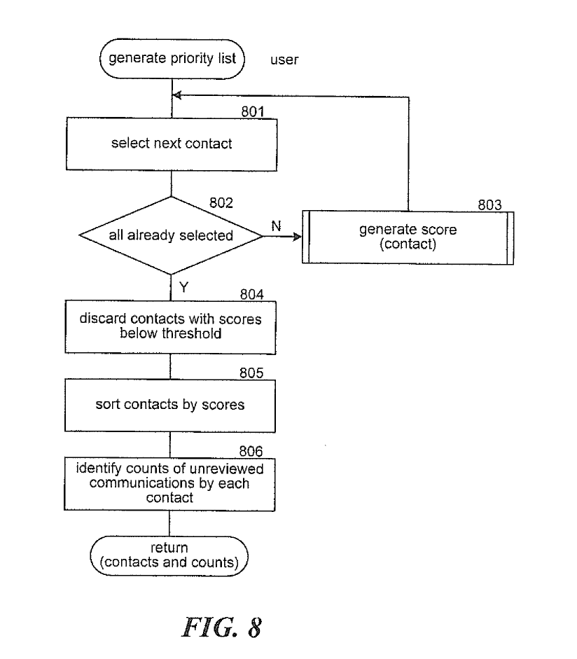

FIG. 8 is a flow diagram that illustrates the processing of the generate priority list component of the prioritization system in some embodiments. The component is passed an indication of the user and generates the priority list that includes the identification of the contacts with a score that satisfies the priority criterion and the counts of the communications from those contacts that have not yet been reviewed by the user. Blocks 801-803 correspond to an embodiment of, for each of a plurality of contacts, analyzing communications generated by the user for review by that contact. In the embodiment of blocks 801-803, the component loops generating a score for each contact. In block 801, the component selects the next contact. In decision block 802, if all the contacts have already been selected, then the component continues at block 804, else the component continues at block 803. In block 803, the component invokes the generate score component passing an indication of the selected contact and receives an indication of the score in return and then loops to block 801 to select the next contact. Block 804 corresponds to an embodiment of selecting contacts for which the analysis of the communications generated by the user for review by the contact indicates that the analyzed communications satisfy a priority criterion. In the embodiment of block 804, the component discards the contacts with scores that do not satisfy the priority criterion (e.g., below a threshold value). In block 805, the component sorts the contacts by their scores. In block 806, the component counts the number of communications that have not been reviewed by each contact. The component may also discard those contacts with a count of zero. Alternatively, in block 801, the component may select only those contacts who have generated a communication that has not yet been reviewed by the user. The component then returns an indication of the contacts and their counts.

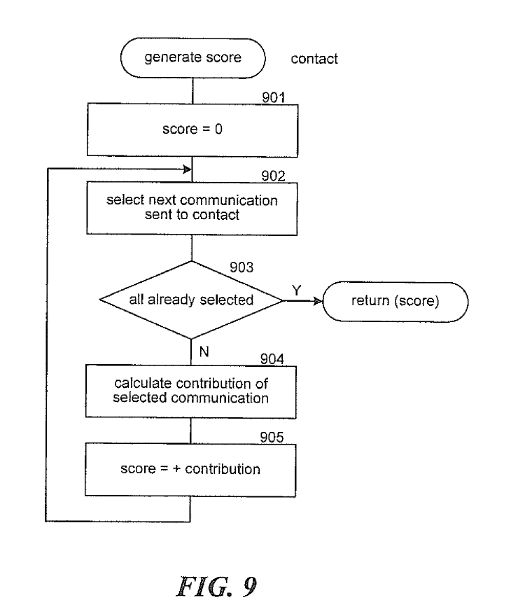

FIG. 9 is a flow diagram that illustrates the processing of the generate score component of the prioritization system in some embodiments. The component is passed an indication of a contact and returns a score for that contact. In block 901, the component initializes the score for the contact. In block 902, the component selects the next communication sent from the user to that contact. In decision block 903, if all the communications have already been selected, then the component returns the score, else the component continues at block 904. In block 904, the component calculates a contribution of the selected communication to the score. The component may use various techniques to determine the contribution of a communication. For example, the component may reduce the contribution of a communication over time so that the contributions of more recent communications are higher than the contributions of less recent communications. In addition, the component may factor in the type of communication into calculating the contribution. For example, the contribution of a text message may be higher than the contribution of an email or a blog posting. The component may also factor in attributes of the contact into calculating the contribution. For example, the communications of a contact who sends many communications to the user that are not reviewed by the user may be given a low contribution. As another example, the communications of a contact in certain organizations (e.g., clients or customers) may be given a higher contribution. As another example, the prioritization system may evaluate the average time between receipt of a communication for a certain contact and review of that communication by the user. In block 905, the component adds that contribution to the score and then loops to block 902 to select the next communication sent to the contact.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, techniques of the prioritization system may be used to identify communications that should be sent to the user's mobile device. Rather than sending a user's entire inbox to a mobile device, the communication system (e.g., email system) may use components of the prioritization system to identify the communications of contacts whose scores satisfy the priority criterion and send only those communications to the mobile device. As another example, the prioritization system may be used to automatically send a text message or a telephone call to a user, for example, when the user receives a communication from a contact with a particularly high score. The term “contact” refers to any entity (e.g., a person, a group of people, an organization, a device, and a computing system) that a user can communicate with. A contact is not limited to only those entities that appear in a contact list or address book. Accordingly, the invention is not limited except as by the appended claims.

1. A computer-readable storage medium for storing computer-executable instructions for controlling a computing device to prioritize communications for review by a user, the communications being generated by a contact for review by the user, the computer-executable instructions comprising instructions that:
for each of a plurality of contacts, analyze communications generated by the user for review by that contact;
select contacts for which the analysis of the communications generated by the user for review by the contact indicates that the analyzed communications satisfy a priority criterion; and
present to the user indications of communications generated by at least some of the selected contacts for review by the user.

2. The computer-readable storage medium of claim 1 including instructions that identify selected contacts that have generated at least one communication that has not yet been reviewed by the user and wherein the indications are indications of the communications of the identified contacts that have not yet been reviewed by the user.

3. The computer-readable storage medium of claim 1 wherein the instructions that present indications to the user include instructions that present identifiers of the contacts who generated the communications that have not been reviewed.

4. The computer-readable storage medium of claim 3 wherein the instructions that present an identifier of a contact include instructions that present a count of the communications generated by that contact that have not been reviewed by the user.

5. The computer-readable storage medium of claim 1 wherein the instructions that present indications to the user include instructions that present a list of the communications of the selected contacts that have not yet been reviewed by the user.

6. The computer-readable storage medium of claim 5 wherein the list groups the communications by the contacts who generate the communications.

7. The computer-readable storage medium of claim 1 wherein the communications are selected from a group consisting of an electronic mail message, a text message, an instant message, a voice mail message, and a modified document.

8. The computer-readable storage medium of claim 1 wherein the analysis of the communications factors in how recently the user communicated with that contact.

9. The computer-readable storage medium of claim 8 wherein the analysis of the communications factors in frequency at which the user communicated with that contact.

10. The computer-readable storage medium of claim 1 including instructions that generate a score for a contact based on analysis of the communications and wherein the indications are presented to the user in an order based at least in part on the scores of the contacts who generated the communications.

11. A method performed by a computing device for prioritizing communications for review by a user, the communications being sent by a contact to the user, the method comprising:
for each of a plurality of contacts, generating for that contact a score based at least in part on frequency and recency of the communications that the user sent to that contact;
selecting the contacts whose scores satisfy a priority criterion;
identifying selected contacts that have sent to the user at least one communication that has not yet been reviewed by the user; and
presenting to the user indications of the communications of the identified contacts that have not yet been reviewed by the user, such that the indications are presented to the user in an order based at least in part on the scores of the contacts who sent communications that have not been reviewed by the user.

12. The method of claim 11 wherein the presenting to the user includes presenting identifiers of the contacts who sent the communications that have not been reviewed.

13. The method of claim 12 wherein the presenting includes, for each identified contact, presenting a count of the communications that have not been reviewed.

14. The method of claim 11 wherein the presenting includes presenting a list of the communications of the identified contacts that have not yet been reviewed by the user.

15. The method of claim 11 wherein the communications are selected from a group consisting of an electronic mail message, a text message, an instant message, a voice mail message, and a modified document.

16. The method of claim 15 wherein the generating of the score for a contact is further based in part on type of communication used in communicating with that contact.

17. A computing device for prioritizing communications for review by a user, the communications being sent by a contact to the user for review by the user, the computing device comprising:
a memory storing computer-executable instructions for controlling the computing device to:
for each of a plurality of contacts, generate for that contact a score based at least in part on how recently and frequently the user sent a communication to that contact;
select the contacts whose scores are above a threshold level;
identify selected contacts that have sent to the user at least one communication that has not yet been reviewed by the user; and
present to the user identifiers of the identified contacts along with a count of the communications sent by each identified contact that have not yet been reviewed by the user, such that the identifiers of the selected contacts are presented to the user in an order based at least in part on the scores of the contacts who sent the communications; and
a processor that executes the computer-executable instructions stored in the memory.

18. The computing device of claim 17 wherein the communications are selected from a group consisting of an electronic mail message, a text message, an instant message, a voice mail message, and a modified document.

19. The computing device of claim 18 wherein the generating of the score for a contact is further based in part on type of communication used in communicating with that contact.

20. The computing device of claim 19 wherein the instructions that present an identifier of a contact include instructions that present a count of the communications generated by that contact that have not been reviewed by the user.
